(19) United States
(12) Patent Application Publication
(10) Pub. No.: US 2020/0191371 A1
(43) Pub. Date: Jun. 18, 2020

(54) Traffic lighting system based on weather visibility change

(71) Applicant: Lu Wang, Guangzhou City (CN)

(72) Inventor: Lu Wang, Guangzhou City (CN)

(21) Appl. No.: 16/796,936

(22) Filed: Feb. 20, 2020

(30) Foreign Application Priority Data
Oct. 12, 2019 (CN) 201910968576X

(51) Int. Cl. F21V 23/04; F21V 1/14

(52) U.S. Cl. CPC F21V 23/0464; F21Y 2115/10; F21V 1/146

(57) ABSTRACT

The invention discloses a traffic lighting system based on the change of weather visibility, which includes a lampshade, wherein the lampshade is provided with a guide slide cavity, and the guide slide cavity is provided with a monitoring system, which can monitor the weather visibility in real time. A cabinet is rotatably connected to the lower end of the lampshade, and a lighting system is provided in the cabinet. The lighting system is provided with lighting lamps symmetrically. The present invention can switch between LED and high-pressure sodium lamp by monitoring weather visibility. In high-visibility weather, only LED lights are used for lighting, which can reduce energy consumption. When there is low visibility weather such as rain and fog, switching to high-pressure sodium lighting can improve lighting penetrability and ensure the required lighting intensity.

### CROSS-REFERENCES TO RELATED APPLICATIONS

The present application claims priority from Chinese application No. 201910968576X filed on Oct. 12, 2019 which is hereby incorporated by reference in its entirety.

### TECHNICAL FIELD

The present invention relates to the field of lighting, in particular to a traffic lighting system based on weather visibility change.

### BACKGROUND OF THE INVENTION

In road traffic lighting systems, the most commonly used light source is high-pressure sodium lamps. In recent years, with the development of science and technology, LEDs are gradually replacing high-pressure sodium lamps on some roads with their high efficiency and energy saving characteristics. Longer, but because the penetrability of LED lights is not as strong as that of high-pressure sodium lamps, it cannot provide the required lighting intensity in rainy and foggy weather with low visibility, and is prone to traffic accidents. The lighting system can solve the above problems. The present invention can switch between LED and high-pressure sodium lamp by monitoring weather visibility. In high visibility weather, only LED lights are used for lighting, which can reduce energy consumption. When weather with low visibility such as rain and fog occurs Switching to high-pressure sodium lamp lighting can improve the penetrability of the lighting to ensure the required lighting intensity.

### BRIEF SUMMARY OF THE INVENTION

Technical problem: LED lamps have poor penetrability, cannot provide the required lighting intensity when rainy and foggy weather comes, and there is a large hidden danger of road safety.

In order to solve the above problems, a traffic lighting system based on changes in weather visibility is designed in this example. A traffic lighting system based on changes in weather visibility in this example includes a lampshade, and a guide slide cavity is provided in the lampshade. A monitoring system is provided in the sliding cavity. The monitoring system can perform real-time monitoring of weather visibility. The lower end of the lampshaft is rotatably connected to a box body. A lighting system is provided in the box body. Illumination lamp, the light source of the illumination lamp is different, the illumination lamp on the left is an LED, the illumination lamp on the right is a high-pressure sodium lamp, and the two illumination lamps are electrically connected to the monitoring system. When it is high, the monitoring system controls the lighting on the left side to light, and when the weather visibility is low, the monitoring system controls the lighting on the left side to go out and the lighting on the right side to light, A circular plate is rotatably connected to the lower end of the box. The circular plate is provided with a semicircular groove with an upward opening therein. A limiting block fixed to the lower end of the box is slidably installed in the semicircular groove. Make all The circular plate restricts the rotation of the box body, so that the box body rotates within a range of 0 to 180°. The lower end of the circular plate is fixedly connected with a base, and a deceleration cavity is provided in the base. A transmission system is provided in the reduction chamber, and the lighting system is provided at the upper end of the transmission system, and the lighting system can be driven by the transmission system.

Advantageously, the monitoring system includes a visibility sensor fixedly connected to the upper end of the lampshade, the visibility sensor can monitor weather visibility in real time, and the visibility sensor transmits a signal to an electromagnetic relay fixedly connected to the lower end of the visibility sensor. The visibility sensor is electrically connected to the electromagnetic relay, the lower end of the electromagnetic relay extends into the guide slide cavity, and an iron block is slidably provided in the guide slide cavity, and the electromagnetic relay can attract the The iron block slides to the left, and two fixed blocks are fixedly connected to the left inner wall of the guide slide cavity. The fixed block is provided with a guide slot opening to the right, and a compression spring is fixedly connected to the left inner wall of the guide slot. A guide block is fixedly connected to the right side of the compression spring, and the guide block can slide left and right in the guide groove. When the guide block slides to the left, the compression spring is compressed by the guide block and has elastic force. A conductive block is symmetrically fixed to the left and right ends of the guide block, and a conductive sheet is symmetrically fixed to the inner wall of the upper and lower sides of the guide groove. When the conductive block is in contact with the conductive sheet, When the illumination lamp is turned on, when the visibility sensor detects that weather visibility is reduced, the magnetic force of the electromagnetic relay is strengthened; when the visibility sensor detects that weather visibility is increased, the magnetic force of the electromagnetic relay is weakened, and the electromagnetic relay magnetic force is reduced When reinforced, the iron block is further attracted to slide to the left, and the guide block on the lower side is further pushed to slide to the left, so that the conductive block on the lower side is in contact with the conductive sheet. The illuminating lamp lights up, the iron block continues to slide to the left, and then pushes the guide block on the upper side to slide to the left, so that the conductive block on the upper side is in contact with the conductive sheet. The lighting lamp is turned on, and at the same time, the conductive block on the lower side is out of contact with the conductive sheet, and the lighting lamp on the left is turned off.

Preferably, a fixed plate is provided on the right side of the iron block, and the upper end of the fixed plate is fixedly connected to the inner wall of the guide slide cavity. A tensile spring is fixedly connected between the fixed plate and the iron block. When the magnetic force of the electromagnetic relay is strengthened, the iron block is further attracted to slide to the left, so that the tensile spring is stretched to have elastic force. When the magnetic force of the electromagnetic relay is weakened, the tensile spring can pull the iron block toward Sliding to the right, the compression spring can push the guide block to slide to the right.

Beneficially, the transmission system includes a motor fixed in the inner wall of the lower side of the reduction chamber, and the motor is activated when the conductive block on the upper side contacts the conductive sheet, and a worm is connected to the upper end of the motor. The upper end of the worm is meshed and connected to the lighting system. An active pinion is rotatably provided in the reduction chamber. The active pinion is fixedly connected to the worm. A driven large gear, a driven rotating shaft is fixedly connected to the driven large gear, the upper and lower ends of the driven rotating shaft are rotatably connected to the inner walls of the upper and lower sides of the reduction chamber, and the upper side of the driven large gear is rotatable. A driven pinion is provided, the driven pinion is fixedly connected to the driven shaft, and a connecting gear is engaged with the right end of the driven pinion, and a slow shaft is fixedly connected to the connecting gear. The upper end of the slow speed shaft is fixedly connected to the box body, the slow speed shaft and the circular plate are rotationally connected, and the slow speed shaft and the worm are rotatable. When the conductive block on the side is in contact with the conductive sheet, the The start of the machine drives the worm to rotate, drives the lighting system and drives the driving pinion to rotate, drives the driven pinion to rotate, drives the driven shaft to rotate, and then drives the driven The pinion rotates, which in turn drives the connection gear, further drives the slow shaft, and further drives the box. The box rotates 180°, that is, the box moves from the right end of the semicircular groove. Rotate to the left end to reach the limit. At this time, the motor stops rotating. When the conductive block on the upper side of the monitoring system is out of contact with the conductive sheet, the motor is started in the reverse direction, which in turn makes the box. By rotating 180°, the box body is turned from the left end to the right end of the semicircular groove, and the motor stops rotating at this time.

Advantageously, the lighting system includes a cavity provided in the box, the upper end of the worm extends into the cavity and the worm and the box are rotationally connected, and the cavity is rotatable. A worm gear is provided, the left end of the worm gear is engaged with the worm, a transmission shaft is fixed inside the worm gear, the lower end of the transmission shaft is rotatably connected to the inner wall of the lower side of the cavity, and the upper end of the transmission shaft extends to The upper end of the transmission shaft is rotatably connected to the upper inner wall of the synchronization cavity in the box. The left and right symmetrical pulleys are rotatably arranged in the synchronization cavity, and the right pulley is fixedly connected to the pulley. In the transmission shaft, a driven shaft is rotatably provided in the pulley on the left side, a lower end of the driven shaft is fixedly connected to the pulley, and an upper end of the driven shaft is rotatably connected to the synchronization cavity. On the upper inner wall, a conveyor belt is connected between the pulleys on both sides, and the pulley on the right side drives the pulley on the left side through the conveyor belt, so that the pulleys on the left and right sides rotate synchronously. The rear side of the conveyor belt is symmetrical and rotatable with symmetrical gears. The symmetrical gears on both sides are respectively fixedly connected to the driven shaft and the transmission shaft, and a storage cavity is symmetrically formed in the box body, and an opening facing away from the central axis direction is provided in the storage cavity. The storage cavity is provided with a rack that can only slide up and down. One end of the symmetrical gears on both sides far from the center of symmetry is respectively engaged with the racks on both sides, and a slider is fixedly connected to the lower end of the rack. The storage cavity A guide chute is provided symmetrically in the front and back. The guide chute opening faces the central axis. The slider can slide up and down in the guide chute. A bracket is fixed to the inner wall of the lower side of the box. A light pole is hinged to the upper end of the bracket, and the two lighting lamps are respectively fixed to the light poles on both sides, and a return spring is fixedly connected between the lower end of the light pole and the inner wall of the lower side of the box. When the worm wheel is driven to rotate, the belt wheel on the right and the symmetrical gear on the right are rotated, the rack on the right is slid, and the slider on the right is slid. The belt wheel on the right drives the conveyor belt to rotate, and Driving the pulley on the left side to rotate, thereby driving the driven shaft to rotate, driving the symmetrical gear on the left side to rotate, driving the rack on the left side to slide, and driving the slider on the left side to slide When the slider slides down, the lamp pole is further pressed down, so that the lamp pole is extended outward, so that the return spring is compressed and has an elastic force, and the slider slides upward to disengage the lamp. In the case of a lever, the return spring can push the light pole to contract inward, thereby ensuring the extension and contraction of the light pole.

The beneficial effect of the present invention is that the present invention can switch between LED and high-pressure sodium lamp by monitoring weather visibility. In high visibility weather, only LED light is used for lighting, which can reduce energy consumption. When weather with low visibility such as rain and fog occurs, Switching to high-pressure sodium lamp lighting can improve lighting penetrability to ensure the required lighting intensity.

### BRIEF DESCRIPTION OF THE DRAWINGS

For ease of explanation, the present invention is described in detail by the following specific embodiments and the accompanying drawings.

FIG. 1 is a schematic diagram of the overall structure of a traffic lighting system based on changes in weather visibility of the present invention;

FIG. 2 is an enlarged schematic view of “A” of FIG. 1;

FIG. 3 is a schematic structural diagram of the “B-B” direction of FIG. 1;

FIG. 4 is a schematic structural diagram of the “C-C” direction of FIG. 1;

FIG. 5 is a schematic structural diagram of the “D-D” direction of FIG. 1;

FIG. 6 is an enlarged schematic view of “E” of FIG. 1;

FIG. 7 is an enlarged schematic view of “F” of FIG. 1;

FIG. 8 is a schematic structural view of the “G-G” direction of FIG. 7.

### DETAILED DESCRIPTION OF THE INVENTION

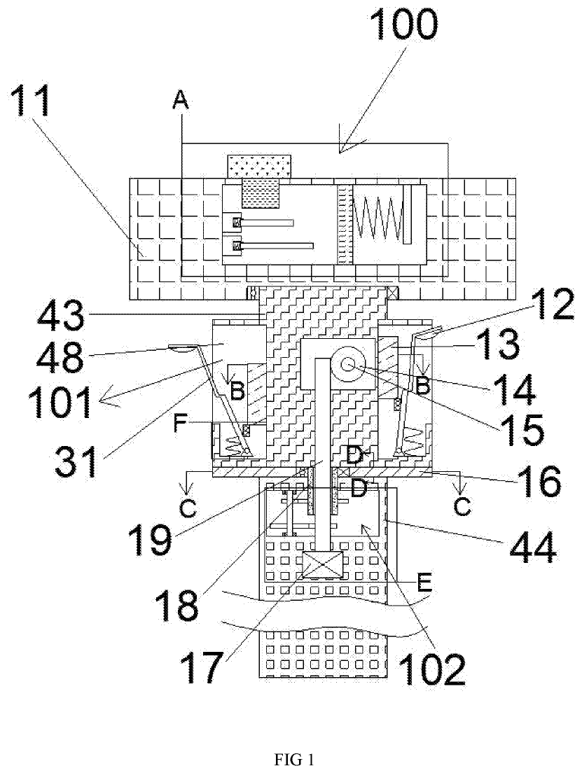

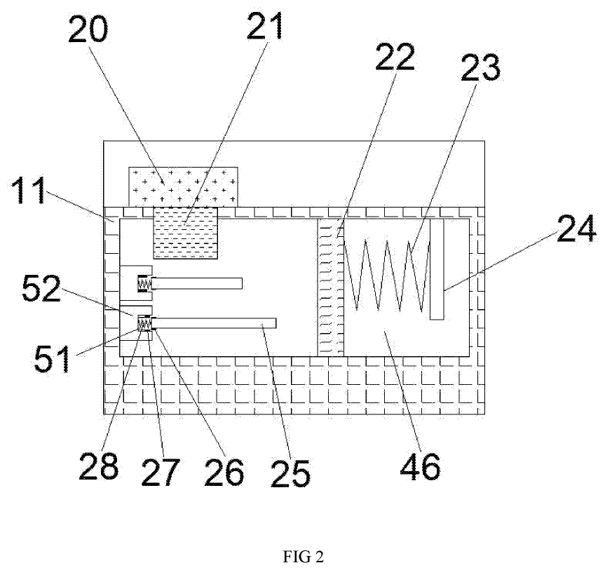

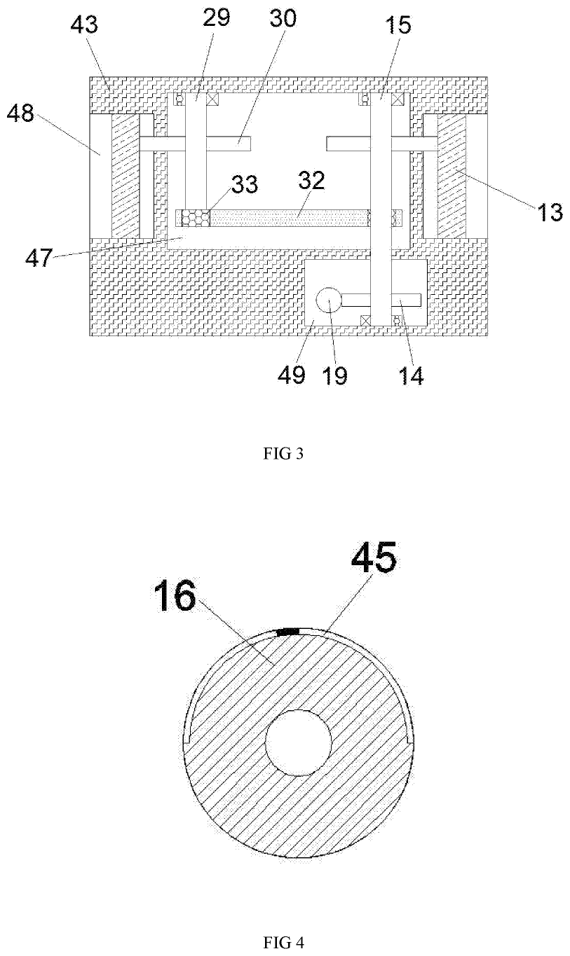

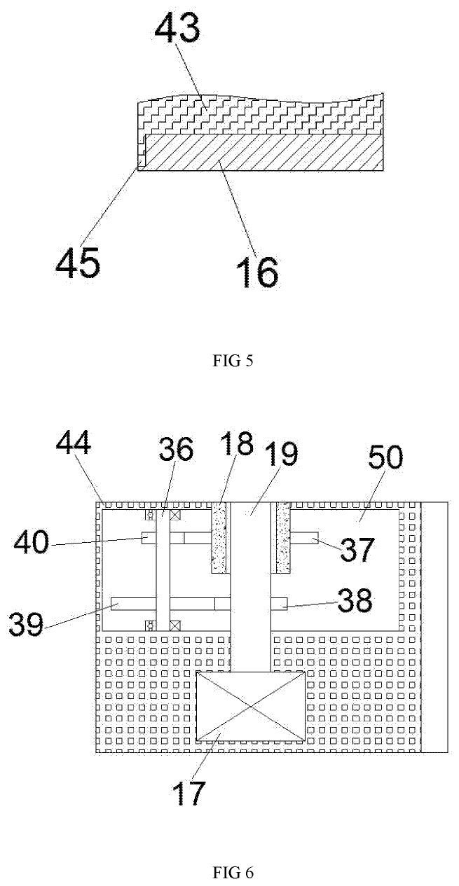

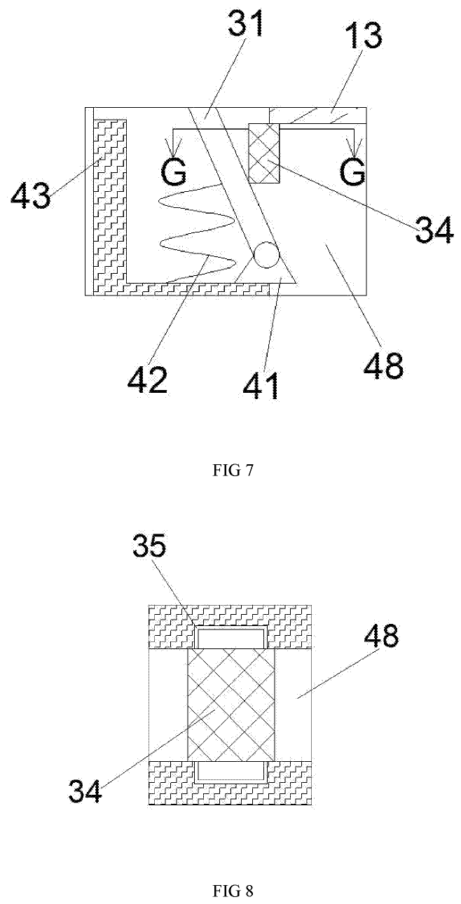

The present invention is described in detail below with reference to FIGS. 1 to 8. For convenience of description, the orientation described below is defined as follows: the up-down, left-right, front-back direction described below is consistent with the up-down, left-right, front-back direction of the projection relationship of FIG. 1 itself.

The present invention relates to a traffic lighting system based on changes in weather visibility, and is mainly applied to weather conditions with relatively low visibility such as rain and fog. The present invention will be further described below with reference to the accompanying drawings of the present invention:

A traffic lighting system based on weather visibility changes according to the present invention includes a lampshade 11. A guiding slide chamber 46 is provided in the lampshade 11, and a monitoring system 100 is provided in the guiding slide chamber 46. The monitoring system 100 The weather visibility can be monitored in real time. A housing 43 is rotatably connected to the lower end of the lampshade 11. The housing 43 is provided with a lighting system 101. The lighting system 101 is provided with lighting lamps 12 symmetrically. The light source of the lamp 12 is different. The lighting lamp 12 on the left is an LED, and the lighting lamp 12 on the right is a high-pressure sodium lamp. The two lighting lamps 12 are electrically connected to the monitoring system 100. When the weather visibility is high, At the time, the monitoring system 100 controls the lighting 12 on the left to light. When the weather visibility is low, the monitoring system 100 controls the lighting 12 on the left to go out and the lighting 12 on the right to Is bright, the lower end of the box 43 is rotatably connected with a circular plate 16. The circular plate 16 is provided with a semicircular groove 45 with an upward opening in the semicircular groove 45. A limiting block at the lower end of the box 43, so that the circular plate 16 faces the The rotation limit of the body 43 allows the box 43 to rotate within a range of 0 to 180°. A base 44 is fixedly attached to the lower end of the circular plate 16, and a deceleration cavity 50 is provided in the base 44. A transmission system 102 is provided in the deceleration chamber 50. The lighting system 101 is provided at the upper end of the transmission system 102. The lighting system 101 can be driven by the transmission system 102.

According to an embodiment, the monitoring system 100 is described in detail below. The monitoring system 100 includes a visibility sensor 20 fixedly connected to the upper end of the lampshade 11. The visibility sensor 20 can monitor weather visibility in real time. The visibility sensor 20 The signal is transmitted to the electromagnetic relay 21 fixedly connected to the lower end of the visibility sensor 20, and the visibility sensor 20 and the electromagnetic relay 21 are electrically connected. The lower end of the electromagnetic relay 21 extends into the guide slide cavity 46. An iron block 22 is slidably provided in the guide slide chamber 46, the electromagnetic relay 21 can attract the iron block 22 to slide to the left, and two fixed blocks 52 are fixed to the left inner wall of the guide slide chamber 46 The fixing block 52 is provided with a guide groove 51 opening to the right, a compression spring 28 is fixedly connected to the left inner wall of the guide groove 51, and a guide block 25 is fixedly connected to the right side of the compression spring 28. 25 can slide left and right in the guide groove 51. When the guide block 25 slides to the left, the compression spring 28 is compressed by the guide block 25 and has elastic force. The upper and lower ends of the guide block 25 are symmetrical on the left side. Conductive 26. A conductive sheet 27 is fixedly connected to the inner walls of the upper and lower sides of the guide groove 51 symmetrically. When the conductive block 26 is in contact with the conductive sheet 27, the lighting lamp 12 can be turned on. When the visibility sensor 20 When a decrease in weather visibility is detected, the electromagnetic relay 21 is magnetically strengthened. When the visibility sensor 20 detects an increase in weather visibility, the electromagnetic relay 21 is weakened magnetically, and when the electromagnetic relay 21 is strengthened magnetically, the iron is attracted to the iron. The block 22 slides to the left, thereby pushing the guide block 25 on the lower side to slide to the left, so that the conductive block 26 on the lower side contacts the conductive sheet 27. At this time, the lighting lamp on the left is 12 o'clock On, the iron block 22 continues to slide to the left, and then pushes the guide block 25 on the upper side to slide to the left, so that the conductive block 26 on the upper side is in contact with the conductive sheet 27. The lighting lamp 12 is turned on, and at the same time, the conductive block 26 on the lower side is out of contact with the conductive sheet 27, and the lighting lamp 12 on the left is turned off.

Beneficially, a fixing plate 24 is provided on the right side of the iron block 22, an upper end of the fixing plate 24 is fixedly connected to the inner wall of the guide slide cavity 46, and a pull is fixedly connected between the fixing plate 24 and the iron block 22. The extension spring 23, when the magnetic force of the electromagnetic relay 21 is strengthened, further attracts the iron block 22 to slide to the left, so that the tension spring 23 is stretched to have elastic force. When the magnetic force of the electromagnetic relay 21 is weakened, the The tension spring 23 can pull the iron block 22 to slide to the right, and the compression spring 28 can push the guide block 25 to slide to the right.

According to the embodiment, the transmission system 102 is described in detail below. The transmission system 102 includes a motor 17 fixed in the inner wall of the lower side of the reduction chamber 50. When the conductive block 26 on the upper side is in contact with the conductive When the plate 27 contacts, the motor 17 is started. A worm 19 is connected to the upper end of the motor 17. The upper end of the worm 19 is connected to the lighting system 101. An active pinion 38 is rotatably provided in the reduction chamber 50. The driving pinion 38 is fixedly connected to the worm 19, and a driven large gear 39 is provided at the left end of the driving pinion 38 in mesh with the driven large shaft 39. The upper and lower ends of the driven rotating shaft 36 are rotatably connected to the inner walls of the upper and lower sides of the reduction chamber 50. A driven pinion 40 is rotatably provided on the upper side of the driven large gear 39, and the driven pinion 40 is fixedly connected. On the driven rotating shaft 36, a right side of the driven pinion 40 is provided with a connection gear 37. A slow shaft 18 is fixedly connected to the connecting gear 37, and an upper end of the slow shaft 18 is fixedly connected to the shaft. Said case 43, said slow speed axis 18 and said circular plate 16 are rotationally connected, said slow speed 18 and the worm 19 are rotatable. When the conductive block 26 on the upper side of the monitoring system 100 is in contact with the conductive sheet 27, the motor 17 is started to drive the worm 19 to rotate. Further driving the lighting system 101 and driving the driving pinion gear 38 to rotate, thereby driving the driven pinion gear 39 to rotate, further driving the driven shaft 36 to rotate, and further driving the driven pinion gear 40 to rotate, further Drive the connecting gear 37 to rotate, and then drive the slow shaft 18 to rotate, and then drive the box 43 to rotate, the box 43 is rotated 180°, that is, the box 43 is moved from the semi-circular groove 45 The right end is turned to the left end to reach the limit, at which time the motor 17 stops rotating. When the conductive block 26 on the upper side of the monitoring system 100 and the conductive sheet 27 are out of contact, the motor 17 starts in the reverse direction. Then, the box body 43 is rotated by 180°, that is, the box body 43 is turned from the left end to the right end of the semicircular groove 45, and at this time, the motor 17 stops rotating.

According to an embodiment, the lighting system 101 is described in detail below. The lighting system 101 includes a cavity 49 provided in the box 43. The upper end of the worm 19 extends into the cavity 49 and the A worm 19 is rotatably connected to the box 43. A worm wheel 14 is rotatably provided in the cavity 49. The left end of the worm wheel 14 is engaged with the worm 19, and a transmission shaft 15 is fixed in the worm wheel 14. The lower end of the transmission shaft 15 is rotatably connected to the inner wall of the lower side of the cavity 49. The upper end of the transmission shaft 15 extends to a synchronization cavity 47 provided in the box 43. The upper end of the transmission shaft 15 is rotatably connected to the The upper inner wall of the synchronization cavity 47 is provided with a left-right symmetrical pulley 33 rotatable in the synchronization cavity 47. The right pulley 33 is fixedly connected to the transmission shaft 15 and the left pulley. A driven shaft 29 is rotatably provided in 33. The lower end of the driven shaft 29 is fixedly connected to the pulley 33. The upper end of the driven shaft 29 is rotatably connected to the upper inner wall of the synchronization cavity 47. A conveyor belt 32 is connected between the pulleys 33, and the pulley 33 on the right side drives the pulley 33 on the left side through the conveyor belt 32. The left and right sides of the belt pulley 33 are rotated synchronously. The rear side of the conveyor belt 32 is symmetrical and rotatable with symmetrical gears 30. The symmetrical gears 30 on the left and right sides are respectively fixed to the driven gear. The shaft 29 and the transmission shaft 15 are provided with a storage cavity 48 symmetrically left and right in the box 43. The storage cavity 48 is provided with an opening facing away from the central axis direction. The sliding rack 13 has one end of the symmetrical gear 30 on both sides far away from the center of symmetry, which is engaged with the racks 13 on both sides. A slider 34 is fixedly connected to the lower end of the rack 13. A guide groove 35 is symmetrically provided. The guide groove 35 is opened toward the central axis. The slider 34 can slide up and down inside the guide groove 35. A bracket is fixed to the inner wall of the lower side of the box 43 41. A light pole 31 is hinged on the upper end of the bracket 41, and the two lighting lamps 12 are respectively fixed to the light poles 31 on both sides. The lower end of the light pole 31 is fixed to the inner wall of the lower side of the box 43. A return spring 42 is connected, and when the worm 19 rotates, the worm wheel 14 is further rotated, thereby driving the right side. The pulley 33 rotates with the symmetrical gear 30 on the right side, thereby driving the rack 13 on the right side to slide, and further sliding the slider 34 on the right side, and the pulley 33 on the right side drives the conveyor belt. 32 turns, which in turn drives the pulley 33 on the left side, further drives the driven shaft 29, and further drives the symmetrical gear 30 on the left side, thereby driving the rack 13 on the left side to slide, which in turn drives The slider 34 on the left slides, and when the slider 34 slides downward, the light pole 31 is further pressed downward, so that the light pole 31 is extended outward, and the return spring 42 is compressed. With the elastic force, when the slider 34 slides upward from the lamp post 31, the reset spring 42 can push the lamp post 31 to contract inward, thereby ensuring the extension and contraction of the lamp post 31.

The following describes in detail the use steps of a traffic lighting system based on changes in weather visibility in conjunction with FIGS. 1 to 8:

Initially, the weather is highly visible, the magnetic relay 21 is weak in magnetic force, the tension spring 23 and the compression spring 28 are in a normal state. The left side lighting lamp 12 is an LED light, the right side lighting lamp 12 is a high-pressure sodium lamp, and both side lighting lamps 12 are Off, the left rack 13 and slider 34 are in the lower limit position, the left light rod 31 is in the extended state, the left return spring 42 is in the compressed state, the right rack 13 and slider 34 are in the upper limit position, and the right The light pole 31 is in a contracted state, the right return spring 42 is in a normal state, the lower end of the box 43 is in the right limit position, and the motor 17 is not started.

When the visibility sensor 20 detects that the weather visibility is low, the visibility sensor 20 transmits a signal to the electromagnetic relay 21, and the electromagnetic relay 21 is magnetically strengthened, thereby attracting the iron block 22 to slide to the left, and then pushing the lower guide block 25 to slide to the left. When the conductive block 26 is in contact with the conductive sheet 27, the signal is transmitted to the left side lighting lamp 12 and the left side lighting lamp 12 is lit. The iron block 22 continues to slide to the left. When the iron block 22 pushes the upper guide block 25 to the When sliding to the left to bring the upper conductive block 26 and the conductive sheet 27 into contact, the lower conductive block 26 is out of contact with the conductive sheet 27, the left side lighting lamp 12 goes out, and the right side lighting lamp 12 receives the signal to light up and start. The motor 17, the motor 17, drives the worm 19 to rotate, thereby driving the driving pinion gear 38, further driving the driven pinion gear 39, further driving the driven shaft 36, further driving the driven pinion 40, and further driving the connecting gear 37. Then, the slow shaft 18 is driven to rotate, and then the box 43 is rotated. The worm 19 is rotated to drive the worm wheel 14 to be rotated, and then the transmission shaft 15 is rotated to drive the right-side pulley 33 and the right-side symmetrical gear 30. This will drive the conveyor belt 32 to rotate. The conveyor belt 32 will drive the left pulley 33 and the right pulley 33 to rotate synchronously, and then drive the driven shaft 29 to rotate, and then drive the left symmetrical gear 30 to rotate. The left and right symmetrical gear 30 will be synchronized. Rotate in the same direction, and then the left symmetrical gear 30 drives the left rack 13 to slide upward, and then drives the left slider 34 to slide upward, and then the left return spring 42 pushes the left lamp rod 31 to move upward, that is, it contracts inward, right The side symmetrical gear 30 drives the right rack 13 to slide downwards, and then drives the right slider 34 to slide downwards, and then pushes the right light pole 31 to extend outward, so that the right return spring 42 is compressed. When the box 43 When the lower end is turned from the right limit position in the semicircular groove 45 to the left limit position, the motor 17 stops rotating. At this time, the right side lighting lamp 12 in the initial position is turned to the left, and the left side lighting lamp 12 in the initial position. Turned to the right.

When the visibility sensor 20 detects that the weather visibility is high, the visibility sensor 20 transmits a signal to the electromagnetic relay 21, the magnetic force of the electromagnetic relay 21 weakens, the tension spring 23 pulls the iron block 22 to return to the initial position, and the compression spring 28 pushes the guide block 25 to return to In the initial position, the box 43 is turned back to the extreme position at the right end of the semi-circular groove 45, the light poles 31 on both sides return to the initial position, the lighting lamps 12 on both sides are turned off, and the motor 17 stops rotating.

The beneficial effect of the present invention is that the present invention can switch between LED and high-pressure sodium lamp by monitoring weather visibility. In high visibility weather, only LED light is used for lighting, which can reduce energy consumption. When weather with low visibility such as rain and fog occurs, Switching to high-pressure sodium lamp lighting can improve lighting penetrability to ensure the required lighting intensity.

In the above manner, those skilled in the art can make various changes according to the working mode within the scope of the present invention.

1. A traffic lighting system based on changes in weather visibility, including a lampshade; a guide slide cavity is provided in the lampshade, and a monitoring system is provided in the guide slide cavity, and the monitoring system can monitor weather visibility in real time; a cabinet is rotatably connected to the lower end of the lampshade, and a lighting system is provided in the cabinet. The lighting system is provided with lighting lamps symmetrically. The lighting sources of the lighting lamps are different. The lighting lamps on the left are LEDs. The lighting lamp on the right side is a high-pressure sodium lamp, and the two lighting lamps are electrically connected to the monitoring system; a circular plate is rotatably connected to the lower end of the box body, and a semicircular groove with an upward opening is provided in the circular plate, and a limiting block fixed to the lower end of the box is slidably installed in the semicircular groove. So that the circular plate limits the rotation of the box body, so that the box body rotates within a range of 0 to 180°; a base is fixedly connected to the lower end of the circular plate, and a deceleration cavity is provided in the base. The deceleration cavity is provided with a transmission system. The upper end of the transmission system is provided with the lighting system. Driving the lighting system.

2. The traffic lighting system based on weather visibility change according to claim 1, wherein the monitoring system comprises a visibility sensor fixedly connected to the upper end of the lampshade, and the visibility sensor can monitor weather visibility in real time, and The visibility sensor transmits a signal to an electromagnetic relay fixedly connected to a lower end of the visibility sensor, and the visibility sensor and the electromagnetic relay are electrically connected; the lower end of the electromagnetic relay extends into the guide slide cavity, and an iron block is slidably provided in the guide slide cavity. The electromagnetic relay can attract the iron block to slide to the left and the left inner wall of the guide slide cavity. Two fixing blocks are fixedly connected. The fixing block is provided with a guide slot opening to the right. A compression spring is fixedly connected to the left inner wall of the guide slot, and a guide block is fixedly connected to the right side of the compression spring; the block can slide left and right in the guide groove; when the guide block slides to the left, the compression spring is compressed by the guide block and has elastic force. The conductive blocks are symmetrically fixed to the left and right sides of the guide block, and the inner walls of the upper and lower sides of the guide groove are symmetrical. A conductive sheet is fixedly connected, and when the conductive block is in contact with the conductive sheet, the illumination lamp can be turned on.

3. The traffic lighting system based on weather visibility change according to claim 2, characterized in that: a fixed plate is provided on the right side of the iron block, and the upper end of the fixed plate is fixedly connected to the inner wall of the guide slide cavity, and A tension spring is fixedly connected between the fixed plate and the iron block.

4. The traffic lighting system based on weather visibility change according to claim 1, wherein the transmission system comprises a motor fixedly installed in the inner wall of the lower side of the reduction chamber; a worm is dynamically connected to the upper end of the motor, and the upper end of the worm is meshed and connected to the lighting system. An active pinion is rotatably provided in the reduction chamber, and the active pinion is fixedly connected to the worm. A driven large gear is engaged with the left end of the pinion gear, and a driven rotating shaft is fixedly connected to the driven large gear, and upper and lower ends of the driven rotating shaft are rotatably connected to the upper and lower inner walls of the reduction chamber; a driven pinion gear is rotatably provided on the upper side of the driven pinion gear, the driven pinion gear is fixedly connected to the driven rotating shaft, and a connecting gear is provided at the right end of the driven pinion gear. A slow shaft is fixedly connected to the connecting gear, and the upper end of the slow shaft is fixedly connected to the box body. The slow shaft and the circular plate are rotationally connected, and the slow shaft and the worm are connected to each other. Between turns.

5. The traffic lighting system based on weather visibility changes according to claim 1, characterized in that the lighting system comprises a cavity provided in the box, and the upper end of the worm extends into the cavity and is located in the cavity. The worm is rotationally connected to the case, and a worm gear is rotatably provided in the cavity, and the left end of the worm gear is engaged with the worm; a drive shaft is fixed in the worm gear, the lower end of the drive shaft is rotatably connected to the inner wall of the lower side of the cavity, the upper end of the drive shaft extends to a synchronization cavity provided in the box, and the upper end of the drive shaft is rotatably connected On the upper inner wall of the synchronization cavity, left and right symmetrical pulleys are rotatably provided in the synchronization cavity. The right pulley is fixedly connected to the transmission shaft, and the left pulley is rotatable inside. With a driven shaft; the lower end of the driven shaft is fixedly connected to the pulley, the upper end of the driven shaft is rotatably connected to the upper inner wall of the synchronization cavity, a belt is connected between the pulleys on both sides, and the right side The pulley drives the pulley on the left side to rotate through the conveyor belt, so that the pulleys on the left and right sides rotate synchronously. The rear side of the conveyor belt is symmetrical and rotatable with symmetrical gears. The symmetrical gears are respectively fixed to the driven shaft and the transmission shaft; a storage cavity is provided symmetrically in the box body. The storage cavity is provided with an opening facing away from the central axis. The storage cavity is provided with a rack that can only slide up and down. The symmetrical gears on both sides are away from the symmetry. One end of the center is respectively engaged with the racks on both sides, and a slider is fixedly connected to the lower end of the rack. A guide groove is symmetrically arranged in the back and forth in the storage cavity, and the opening of the guide groove faces the central axis. The slider can slide up and down in the guide chute, a bracket is fixedly connected to the inner wall of the lower side of the box, a lamp pole is hinged on the upper end of the bracket, and the two lighting lamps are respectively fixed to the two sides of the guide lamp. A light pole, a return spring is fixedly connected between the lower end of the light pole and the inner wall of the lower side of the box.
